(19) United States
(12) Patent Application Publication
(10) Pub. No.: US 2020/0060306 A1
(43) Pub. Date: Feb. 27, 2020

(54) SOFT ICE CREAM DISPENSER CONFIGURED FOR INJECTING DOUGHNUTS

(71) Applicant: Robert Evans, Chautauqua, NY (US)

(72) Inventor: Robert Evans, Chautauqua, NY (US)

(21) Appl. No.: 16/546,675

(22) Filed: Aug. 21, 2019

Related U.S. Application Data
(60) Provisional application No. 62/722,005, filed on Aug. 23, 2018.

(51) Int. Cl. A23G 9/28; A21C 15/00; A23G 9/22; A23G 9/24; A23G 9/48

(52) U.S. Cl. CPC A23G 9/288; A21C 15/007; A23G 9/228; A23G 2220/22; A23G 9/48; A23G 2220/20; A23G 9/24

(57) ABSTRACT

Apparatus for injecting ice cream through a sleeve and nozzle into pastries receives ice cream from soft-serve ice-cream machines. The sleeve is temperature controlled by electric heating element, temperature sensor, and controller. The nozzle has a pointed tip and deposits an ice cream stream, optionally including a flavored syrup injected into its center as it flows through the nozzle, into a ball in a pastry. Another nozzle formed with openings on opposite sides of the tip deposits ice cream with ripple effect. A method of injecting ice cream into pastries includes positioning a pastry with injector nozzle tip in the pastry; flowing ice cream through a temperature controlled injection device and nozzle into the pastry; and removing the pastry. In embodiments, the method includes injecting flavored syrup into a center of a stream of ice cream and deposits the ice cream in a ball or rippled stream within a pastry.

### PRIORITY CLAIM

The present document claims priority to U.S. Provisional Patent Application No. 62/722,005 filed Aug. 23, 2018. The entire contents of the aforementioned provisional application are incorporated herein by reference.

### SUMMARY

An apparatus for injecting ice cream into pastries has a liner adapted to receive ice cream from a soft-serve ice-cream freezing-dispensing machine and a sleeve and nozzle to receive the ice cream configured with a heating element to adjust temperature of the ice cream that touches faces of the sleeve thereby reducing friction between ice cream, sleeve, and nozzle, a temperature sensor and controller adapted to regulate heat provided by the heating element. In embodiments, the nozzle has a pointed tip with openings on opposite sides of the tip and configured to deposit ice cream as a ball in a doughnut, and an injection inlet and injection nozzle adapted to inject flavored syrup into a center of the ice cream stream as it passes through the sleeve and nozzle. A method of injecting ice cream into pastries includes positioning a pastry with an injector nozzle tip in the pastry; flowing ice cream through a temperature controlled injection device and nozzle into the pastry; and injecting flavored syrup into a center of the ice cream.

### BRIEF DESCRIPTION OF THE FIGURES

FIG. 1 is a schematic illustration of a system for implanting ice cream into fresh-fried, round or rectangular, pastries to provide ice-cream-filled “doughnuts,” eclairs, and bars.

FIG. 1A is a schematic illustration of a liquid heat-exchanger temperature regulation device used in an alternative embodiment.

FIG. 1B is a schematic illustration of the system for implanting ice cream into pastries of FIG. 1 with additional components including a flavored syrup reservoir, syrup injection pump, and syrup injection nozzle configured to inject syrup into a center of the ice cream stream.

FIG. 2 is an exploded view of the electric temperature regulation device of FIG. 1.

FIG. 3 is a cross sectional view of the electric temperature regulation device of FIG. 2.

FIG. 4 is an exploded view of a temperature regulation device adapted with multiple flavor-syrup injection ports for injecting flavored syrup into a center of the ice cream as the ice cream flows through the temperature regulation device into the nozzle.

FIG. 5 is a cross sectional view of the temperature regulation device of FIG. 4.

FIGS. 6A and 6B are illustrations of a trimmed and partially formed injector nozzle of FIG. 1-5, use of the partially formed nozzle allows a mass rippled effect of injected ice cream in a center of the pastry.

FIG. 6C is an illustration of a formed injector nozzle, use of the fully formed injector nozzle allows a ripple effect of injected ice cream.

FIG. 7 is a flowchart of a method of forming ice-cream-filled pastries.

### DETAILED DESCRIPTION OF THE EMBODIMENTS

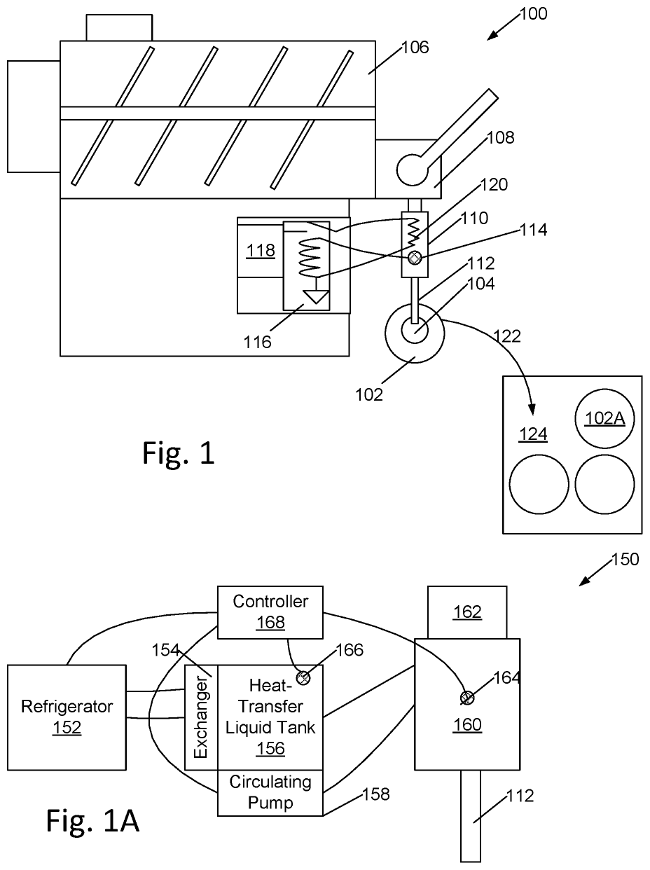

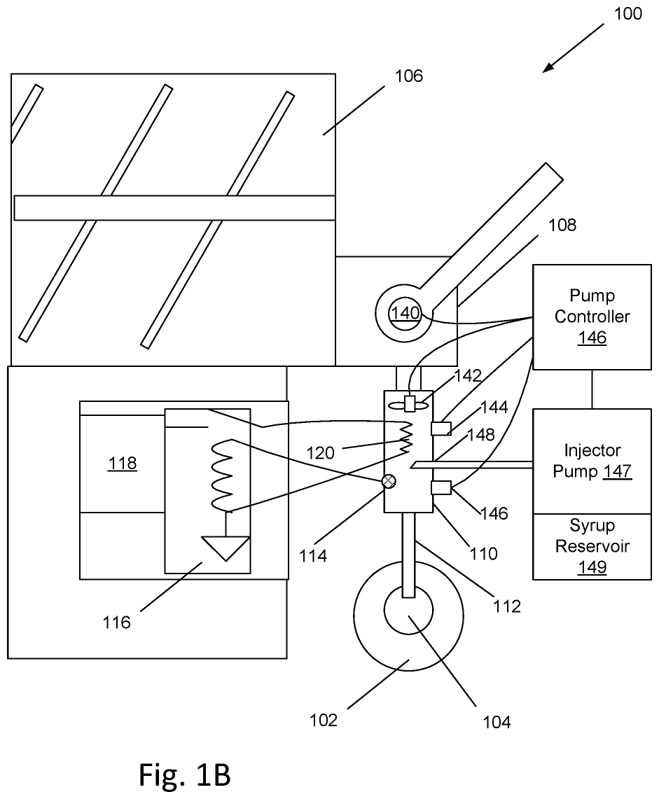

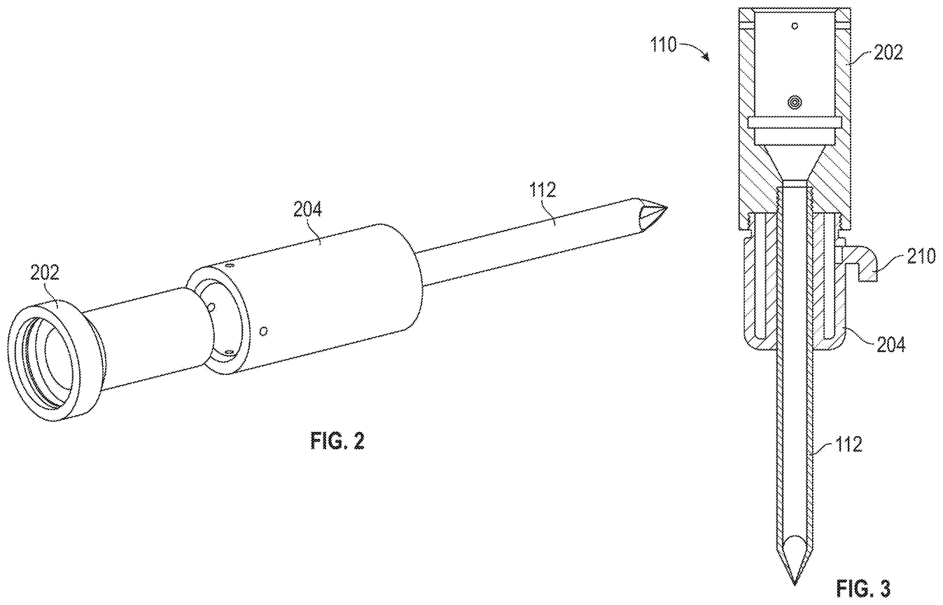

A system 100 (FIG. 1) for implanting soft ice-cream 104 into round or rectangular pastries 102 such as fresh-fried no-hole yeast-raised doughnuts, eclairs, and bars includes a soft ice-cream dispensing machine 106. The ice-cream dispensing machine 106 has a dispensing valve 108 coupled to dispense ice-cream into and through a temperature regulating device 110 having a liner fitting 202 (FIG. 2) and an injector nozzle 112. The injector nozzle 112 injects ice cream from the temperature regulating device into a pastry 102 positioned with an injector nozzle within the pastry so as to receive the ice cream 104 internal to pastry 102.

Temperature regulating device 110 has a temperature sensor 114, which in an embodiment is an adjustable thermostat and in an alternative embodiment is a thermistor associated with an electronic control. Temperature sensor 114 is configured with an electromechanical or electronic controller 116 that couples a power supply 118 to an electric resistive heater 120 of the temperature regulating device 110 to precisely control temperature of walls of temperature regulating device 110, and thus of outer portions of a stream of ice cream 104. By controlling temperature of the walls of temperature regulating device 110, resistive heater 120 and temperature sensor 114 indirectly control consistency of ice cream 104 as the ice cream 104 flows through liner fitting 202 of temperature regulating device 110 and nozzle 112 into pastry 102.

In system 100, nozzle 112 remains stationary while pastries 102 are moved, in an embodiment by hand and in an alternative embodiment by a pastry-handling apparatus, from a pastry supply (not shown in FIG. 1) into a position where a tip of nozzle 112 is located within pastry 102, whereupon the ice cream 104 is injected into pastry 102. After injection of pastry 102, the pastry is moved 122 onto a tray 124 for immediate sale or storage in a freezer (not shown) with other injected pastries 102A. The injection device in some embodiments includes a liner fitting 202, 204 adapted by a sleeve 204, 404 to feed nozzle 112.

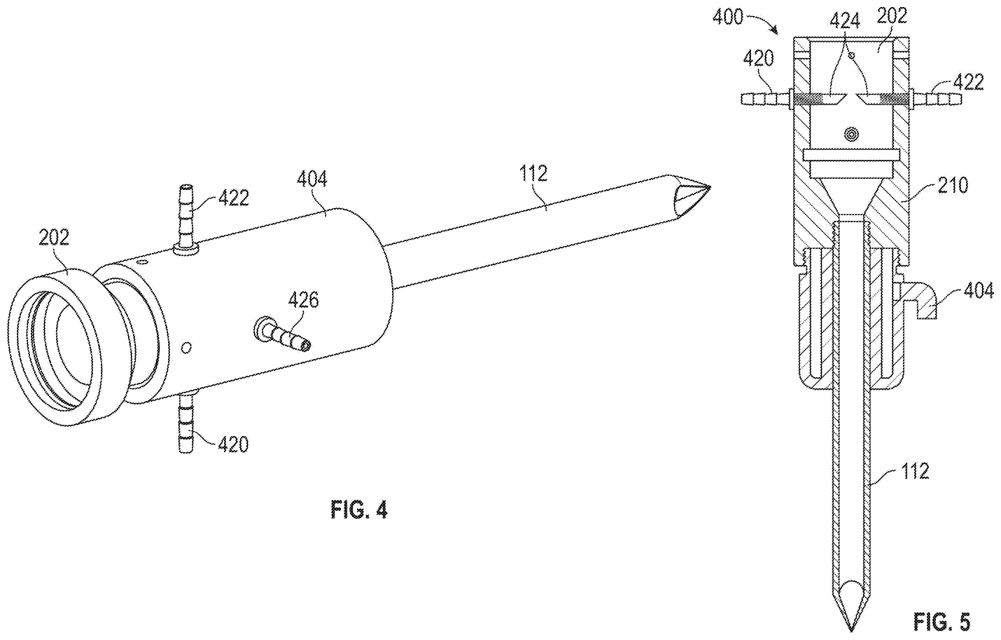

In an alternative embodiment 400 (FIG. 4), the sleeve 404 has one or more, and in an embodiment four, inlets 420, 422, 426 (a fourth inlet is not shown), each of which is coupled to feed a separate nozzle 424; sleeve 404 is otherwise comparable to liner fitting and sleeve 204. The inlets 420, 422, 426 are adapted for injection of a selected syrup, the syrup selected from four possible flavored syrups, each syrup may, if selected, feed through a separate syrup nozzle, such as syrup nozzle 424, to add a stream of flavored syrup to a center of a stream of ice cream passing through sleeve 204 and nozzle 112 into pastry 102.

In an embodiment for use with rectangular or bar-shaped pastries, the pastry 102 may be positioned such that the nozzle is initially inserted deep into the pastry, then the pastry is shifted along nozzle 112 while the ice cream 104 is being injected into the pastry to leave a central rod-shaped ice cream deposit with any selected and injected flavored syrup deposited by a syrup nozzle 424 concentrated within the center of ice cream 104 deposited within pastry 102.

In alternative embodiments, heater 120 is adapted with multiple resistances to have multiple temperature production settings. In an alternative embodiment, controller 116 is a digital proportional controller adapted to pulse-width modulate power to heater 120, thereby providing an infinite range of heating settings, and adapted to automatically select an appropriate heating setting to maintain ice cream temperature of outside portions of the ice cream stream at the entrance to nozzle 112 at a predetermined temperature and thus consistency.

In an alternative embodiment, electric temperature regulating device 110 is replaced with a liquid heat-exchange temperature regulating system 150, as illustrated in FIG. 1A. In this embodiment, a mechanical or thermoelectric refrigeration unit 152 operates through a heat exchanger 154 to cool a heat transfer liquid in a heat transfer liquid tank 156. A transfer pump 158 is configured to pump the heat transfer liquid through temperature regulating device 160 that acts as a heat exchanger between the heat transfer liquid and the ice cream as the ice cream flows from a fitting 162 adapted to attach to the ice cream machine into nozzle 112. In this embodiment, temperature sensors 164, 166 provide temperature readings from both the temperature regulating device 160 and heat transfer liquid tank 156 to a controller 168. Controller 168 adjusts operation of refrigeration unit 152 and transfer pump 158 to maintain proper temperature of the temperature regulating device 160 and ice cream 104 as the ice cream flows into pastry 102.

In the alternative embodiment with liquid heat-exchanger, a non-toxic, low-melting point, fluid bearing a brightly-colored indicator dye is used to ensure leaks are promptly detected and thereby avoid injury to customers.

In both the embodiments of FIGS. 1 and 1A, the temperature regulating device 110, 160, is adapted to slide onto, and be secured by a setscrew (not shown) to, a standard output nozzle or fitting of ice cream machine 106.

An exemplary electric temperature regulating device 110 and nozzle 112 is illustrated in FIG. 2. Temperature regulating device 110 includes a liner fitting 202 adapted to receive ice cream from the ice cream freezing-dispensing machine 106, nozzle 112, and a sleeve 204 that adapts liner fitting 202 to nozzle 112 and contains an electric heating element (not shown) near nozzle 112, and a temperature sensor 210 configured to sense temperature of the sleeve, nozzle, and flowing ice cream. Temperature sensor 210 is attached to sleeve 204.

In the embodiments of FIGS. 1, 2, 3, 4, and 5, the electric heating element is formed as a cylinder of approximately three-inch diameter.

In an alternative embodiment 400 (FIG. 4), the sleeve 404 has one or more, and in an embodiment four, inlets 420, 422, 426 (a fourth inlet is not shown) each of which is coupled to feed a separate nozzle 424; sleeve 404 is otherwise comparable to sleeve 204. The inlets 420, 422, 426 are adapted for injection of one of four user-selected flavored syrups that feed through separate nozzles 424 to add a stream of flavored syrup to a center of a stream of ice cream passing through sleeve 204 and nozzle 112 into pastry 102.

In some embodiments, as illustrated in FIG. 1B, volume of injection of the selected flavored syrup is controlled to be at a rate proportional to a flow rate of ice cream through the sleeve to provide a consistent ratio of syrup to ice cream and thereby providing a consistent product and consistent user experience. In particular embodiments a flow rate sensor 142 is included within sleeve 204, the flow rate sensor 142 measures flow rate of the ice cream. Injection pump controller 146 uses measurements of flow rate of the ice cream to control the rate of injection of flavored syrup by controlling a flavored syrup injector pump 147 that dispenses flavored syrup with each ice cream injection and provide a consistent ratio of syrup to ice cream. Alternatively, a valve position sensor 140 is provided on ice cream dispensing valve 108, to permit injection pump controller 146 to provide a consistent ratio of an injection volume of flavored syrup by syrup injection pump 147 to an injection volume of ice cream as injected through the sleeve. Either embodiment permits injection of a desired, consistent, ratio of ice cream to flavored syrup injection rates. In a particular embodiment syrup injection pump 147 is a peristaltic pump driven by a stepping motor to provide a wide range of precisely controllable injection rates, and separate peristaltic pumps are provided for each flavored syrup. In this embodiment, a user-operated syrup selection control selects an active peristaltic syrup injection pump and the pump controller controls the selected pump according to a flow sensor in the incoming ice cream stream.

In an embodiment, the apparatus includes a subsystem adapted to receive a user selection of a flavored syrup and to inject the selected flavored syrup through the injection nozzle, the flavored syrup selected by a user, into a center of the stream of ice cream stream. In particular embodiments, the ice cream may be vanilla flavored, while the user may select from injection of no syrup, or from injection of one or more of cola, cherry, chocolate, or strawberry syrups. In this embodiment, additional syrups, such as but not limited to blackberry, caramel, butterscotch, or blueberry syrup, may substitute for one or more of the cola, cherry, chocolate, or strawberry syrups. The system is versatile and may operate with any of a wide selection of flavored syrups, it is not limited to operating with syrup flavors listed in this paragraph.

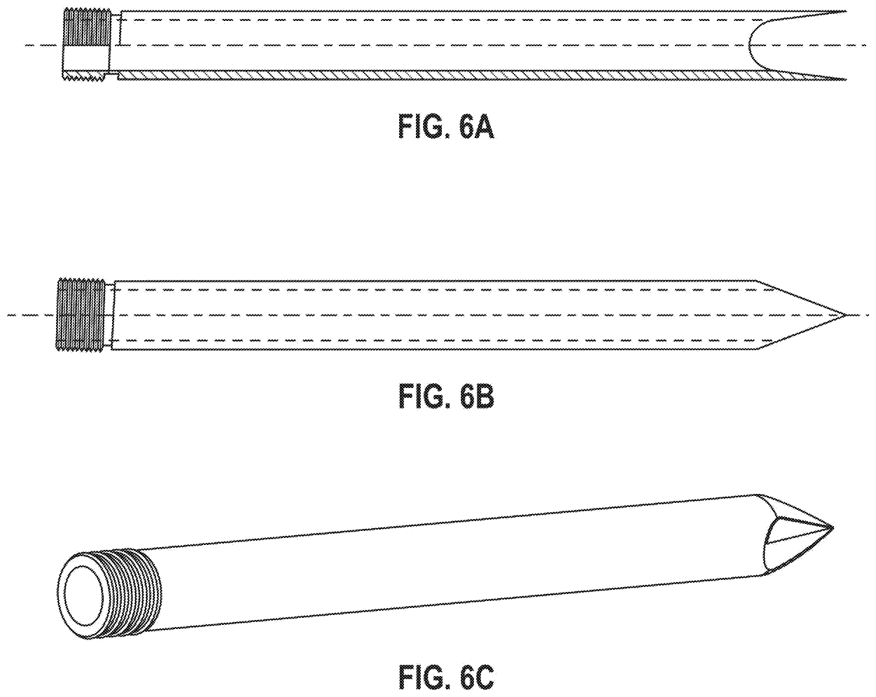

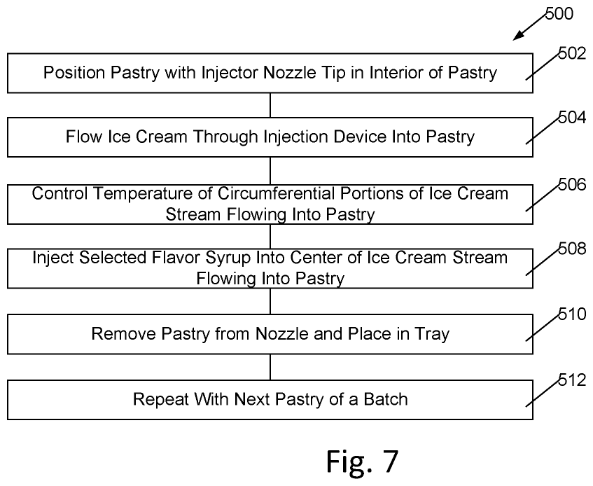

In embodiments herein described, nozzle 112 is initially formed as shown in FIG. 6A as a stainless-steel tube threaded on a first end and with a top and bottom formed into a triangular point on a second end, as illustrated in FIG. 6B. The threaded end of nozzle 112 is engaged into sleeve 204, 404. The top and bottom triangular points may then be bent inward as shown in FIG. 6C to form a pointed injector nozzle tip with openings to sides of the tip. Ice cream passing through the openings to sides of the tip of a nozzle with triangular points bent inwards tends to form a ripple deposition about the tip of nozzle 112. If the triangular points at the tip of the nozzle are not bent inwards, the ice cream tends to form a ball-like deposition with any injected flavored syrup remaining near a center of the ball.

In a method 500 of injecting ice cream into pastries, a pastry is positioned 502 with injector nozzle tip in an interior of the pastry. Ice cream is then flowed 504 through the injection device 110 into pastry 102 while temperature of outer portions of the ice cream stream, such as those adjacent sleeve and heater walls, is controlled 506 to permit easy flow of the ice cream through the nozzle into the pastry. In some embodiments, a selected flavored syrup is also injected 508 into a center of the ice cream stream flowing through the injection device and injection nozzle into the pastry. The pastry is then removed 510 placed in a tray, and steps 502 to 510 are repeated 512 with a next pastry of a batch of pastries

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An apparatus configured for injection of ice cream into pastries, the apparatus comprising:
a sleeve adapted to receive flowing ice cream from a soft-serve ice cream freezing-dispensing machine and direct the flowing ice cream into a nozzle;
the nozzle adapted to receive the flowing ice cream and inject it into the pastries;
the sleeve configured with an electric heating element adapted to adjust temperature of a circumferential portion of the flowing ice cream as the flowing ice cream is directed through the sleeve;
a temperature sensor coupled to sense temperature of the sleeve;
a controller adapted to regulate heat provided by the electric heating element in accordance with temperature sensed by the temperature sensor;
at least one injection inlet and injection nozzle adapted to inject a flavored syrup into a center of the flowing ice cream as it flows through the sleeve and nozzle; and
a syrup pump and syrup pump controller adapted to control a ratio of the flavored syrup to the flowing ice cream as the flowing ice cream flows through the sleeve and nozzle.

2. The apparatus of claim 1, wherein the nozzle has a pointed tip configured with an axial opening to allow deposit of a ball of ice cream within a center of a pastry, with the flavored syrup within the ball of ice cream.

3. The apparatus of claim 1 wherein the nozzle has a pointed tip with openings to sides of the pointed tip configured to provide a deposit of the ice cream with a ripple effect within a pastry.

4. The apparatus of claim 1 further comprising a flow sensor adapted to measure flow rate of the flowing ice cream, the syrup pump controller configured to use readings of the flow sensor to control flow rate of the flavored syrup.

5. The apparatus of claim 4 wherein there are multiple injection inlets, injection nozzles, and syrup pumps each adapted to receive a separate flavored syrup.

6. The apparatus of claim 4 wherein the syrup pump is a peristaltic pump.

7. An apparatus configured for injection of ice cream into pastries, the apparatus comprising;
a sleeve adapted to receive the ice cream and direct the ice cream into a nozzle;
the nozzle adapted to receive ice cream and inject it into the pastries;
the sleeve configured with at least one injection inlet and injection nozzle adapted to inject a flavored syrup into a center of the ice cream flowing through the sleeve.

8. The apparatus of claim 7 wherein there are multiple injection inlets and injection nozzles, each adapted to receive a separate flavored syrup.

9. The apparatus of claim 8 wherein each of the separate flavored syrups is provided to an associated injection nozzle of the injection nozzles by a separate syrup injection pump operating under control of an injection pump controller.

10. The apparatus of claim 9 further comprising a sensor configured to measure a flow rate of the ice cream flowing through the sleeve, and the injection pump controller being adapted to control the syrup injection pumps according to measured flow rate of the ice cream.

11. A method of injecting ice cream into pastries comprising:
positioning a pastry with an injector nozzle tip in an interior of the pastry;
flowing a stream of ice cream through a temperature-controlled injection device and through the injector nozzle into the pastry; and
removing the pastry from the injector nozzle tip.

12. The method of claim 11 further comprising injecting a flavored syrup into a center of the ice cream stream flowing through the temperature controlled injection device.

13. The method of claim 12 further comprising controlling a volume ratio of the flavored syrup to the ice cream stream by sensing flow of the ice cream stream and controlling a pump configured to inject the flavored syrup.

14. The method of claim 13 further comprising:
providing a selector to allow a user to select the flavored syrup from a plurality of flavored syrups.

15. A method of injecting ice cream into pastries comprising:
positioning a pastry with an injector nozzle tip in an interior of the pastry;
flowing a stream of ice cream through an injection device and through the injector nozzle into the pastry;
injecting a selected flavored syrup into a center of the ice cream stream as the ice cream stream is flowing into the injection device; and
removing the pastry from the injector nozzle tip.

16. The method of claim 15, further comprising regulating a temperature of the injection device to control a consistency of the ice cream.

17. The method of claim 15 further comprising controlling a volume ratio of the selected flavored syrup and the ice cream as the ice cream stream flows through the injection device.

18. The method of claim 15 wherein a flow sensor and syrup pump controller are used to control the volume ratio of the selected flavored syrup and the ice cream.

19. The method of claim 15 wherein the injector nozzle has openings lateral to a closed tip and the pastry is positioned such that the ice cream stream is injected into a center of the pastry with a ripple effect.
